(19) United States
(12) Patent Application Publication
(10) Pub. No.: US 2012/0245878 A1
(43) Pub. Date: Sep. 27, 2012

(54) HANDHELD HVAC/R TEST AND MEASUREMENT INSTRUMENT

(75) Inventors: Michael John Kane, Portland, OR (US); David Lauren Wheaton, Sherwood, OR (US); Sean Patrick Tierney, Milwaukie, OR (US)

(73) Assignee: UNIVERSAL ENTERPRISES, INCORPORATED, Beaverton, OR (US)

(21) Appl. No.: 13/072,636

(22) Filed: Mar. 25, 2011

(51) Int. Cl. G06F 19/00

(52) U.S. Cl. 702/116

(57) ABSTRACT

A handheld HVAC/R test and measurement instrument having a display, a keypad, a microprocessor, memory, and circuitry adapted to receive inputs from a plurality of sensors and to automatically determine the type of each sensor and automatically determine and display which HVAC/R tests and measurements are available to be performed by the field service technician using only the plurality of sensors. Different kits of sensors are used for various tests and measurements routinely performed when servicing HVAC/R systems, and the handheld instrument automatically identifies the sensors connected to it and leads the technician through the tests and measurements that can be performed using those sensor inputs in combination with technical reference information and calculation algorithms stored in memory.

### CROSS-REFERENCE TO RELATED APPLICATIONS

None.

### BACKGROUND OF THE INVENTION

The invention involves servicing and testing equipment used in the heating, ventilating, air conditioning, and refrigeration (HVAC/R) field and, more particularly to handheld test and measurement devices useful for HVAC/R technicians for the performance of their vocation.

HVAC/R (or, sometimes referred to simply as HVAC) technicians employ a wide variety of servicing and testing equipment in the daily and routine performance of their vocation. Some of the electrical measuring and test instruments include: voltmeters to measure electric potential differences (volts, V; volts AC, VAC; volts DC, VDC); ohmmeters to measure electric resistance (ohms, Ω); ammeters to measure electric current (amperes, A; alternating current, AC; direct current, DC); capacitance meters to measure electric capacitance (farads); thermocouples to measure temperature (degrees F.); wattmeters to measure electric power (Watts, W); and data logging instruments to capture and store measurement data over time.

Exemplary refrigerant system servicing and testing equipment include: various types of thermometers—dial thermometers, digital thermometers, thermocouples, infrared thermometers; gage manifold sets for measuring operating pressures (kilopascals, kPa; pounds per square inch, psi) in one of three ways—atmospheric (psi), gage (psig), or absolute (psia) pressure—and for adding or removing refrigerant; superheat and subcool meters that measure low side (suction line) pressure and temperature (for determining superheat) and high side (condenser discharge line) pressure and temperature (for determining subcool); psychrometers for measuring wet bulb and dry bulb temperatures to determine relative humidity; and leak detectors such as electronic leak detectors or ultrasonic-type leak detectors for detecting refrigerant leaks.

Heating system servicing and testing equipment may include: draft gages for measuring the amount of draft in inches of water column in the flue pipe opening and in the furnace inspection port (to compare flue draft with manufacturer specifications and to detect leaks); flue gas analyzers for measuring carbon monoxide (CO), carbon dioxide (CO2), oxygen (O2), nitrous oxide (NO), and flue pressure; refrigerant and gas identifiers and monitors; and oxygen-depletion alarms for warning technicians of dangerous conditions in enclosed or confined equipment areas.

Pressure measuring devices include: manometers for measuring small pressures (under one inch water column); and Bourdon tube gages for measuring higher pressures in psig.

Air speed and air volume measuring devices such as rotating vane anemometers, thermal anemometers, and flow hoods are used for measuring air speed (feet per minute, fpm) and air volume (cubic feet per minute, CFM).

Indoor air quality (IAQ) test and measurement devices may include particle counters, infrared cameras, thermal imagers, and various pollutant sampling kits, devices, and sensors—for detecting mold, lead, asbestos, radon, CO, nitrogen dioxide (NO2), mercury, volatile organic compounds (VOC's) such as ketones and hydrocarbons, and ozone (O3)—in addition to instruments to measure CO2 percentage, temperature, and relative humidity percentage.

Numerous techniques are used by HVAC/R technicians to service a wide variety of different types of systems, requiring the technician to acquire, learn to use, and maintain several separate servicing and testing devices as well as accompanying technical reference materials such as refrigerant pressure-temperature charts and calculation algorithms and methods. HVAC/R test and measurement instruments are needed that reduce the number of separate instruments and technical reference materials needed to install and service HVAC/R systems. HVAC/R test and measurement instruments are needed that incorporate greater flexibility, versatility, portability, and functionality than those which are presently available.

What is needed, therefore, are improved techniques and devices designed to help HVAC/R technicians in their vocation by reducing the number and complexity of devices, systems, and technical materials needed to perform various servicing and testing procedures. A handheld sized device or family of related, interconnectable, or multi-purpose devices that may be used for a wide variety of HVAC/R system servicing and testing applications, and that provide the technician with real-time system performance information, guidance in system analysis and troubleshooting, is needed.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

For a more complete understanding of the present invention, the drawings herein illustrate examples of the invention. The drawings, however, do not limit the scope of the invention. Similar references in the drawings indicate similar elements.

FIG. 1 illustrates an exemplary air conditioning and refrigeration system with a handheld HVAC/R test and measurement instrument, according to one embodiment.

FIG. 2 illustrates various embodiments of the handheld HVAC/R instrument shown in FIG. 1 connected with sensor module inputs and external output and peripheral devices.

FIG. 3 illustrates various embodiments of inputs connectable to a handheld HVAC/R instrument as in FIGS. 1 and 2.

FIG. 4 illustrates optional sensor kits for use with a handheld HVAC/R instrument as in FIGS. 1-3, according to various embodiments.

FIG. 5 depicts a partial, generalized operational flow chart of a handheld HVAC/R instrument and sensor kit, according to various embodiments.

FIG. 6 shows an exemplary functional block diagram of a handheld HVAC/R instrument as in FIGS. 1-3, according to various embodiments.

FIG. 7 illustrates various embodiments of a handheld sized test and measurement data interface unit for receiving sensor inputs from sensor kits and providing received sensor input information to a handheld sized user interface.

FIG. 8 shows an exemplary functional block diagram of a handheld sized data interface unit as in FIG. 7, according to various embodiments.

### DETAILED DESCRIPTION OF PREFERRED EMBODIMENTS

In the following detailed description, numerous specific details are set forth in order to provide a thorough understanding of the preferred embodiments. However, those skilled in the art will understand that the present invention may be practiced without these specific details, that the present invention is not limited to the depicted embodiments, and that the present invention may be practiced in a variety of alternate embodiments. In other instances, well known methods, procedures, components, and systems have not been described in detail.

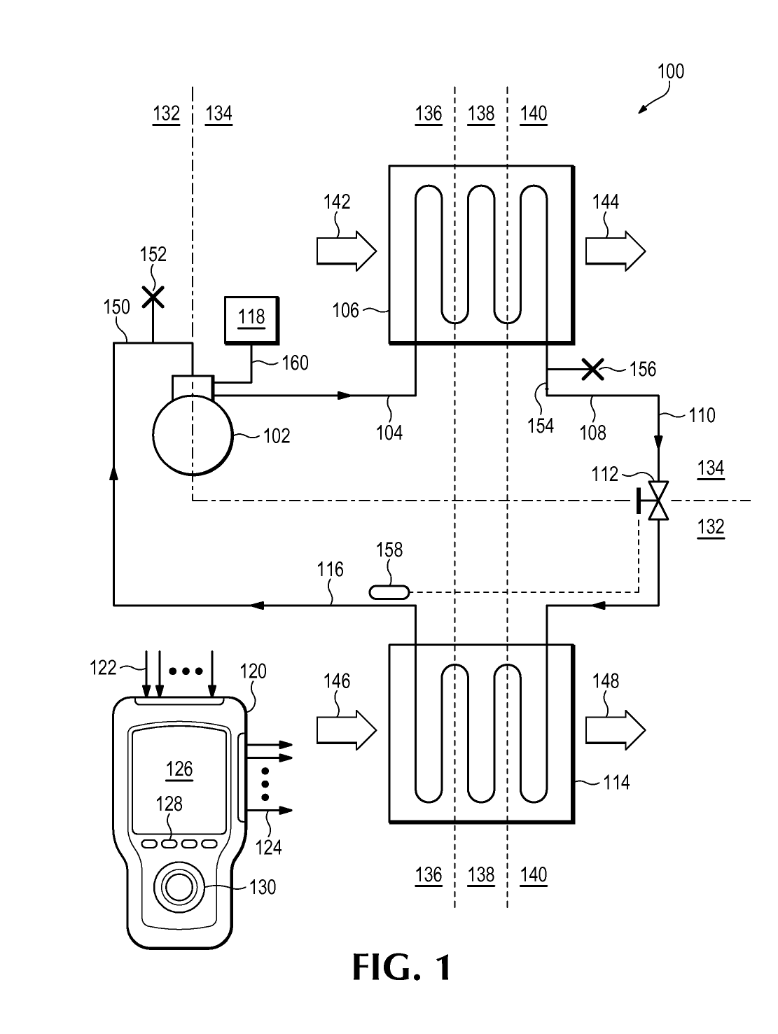

Rather than use several different test and measurement instruments when servicing a system such as that shown in FIG. 1, the present inventors invented a handheld central or main field test and measurement instrument that is capable of receiving inputs from sensors or sensor modules to perform typical tests and measurements associated with installation and maintenance of HVAC/R systems. FIG. 1 shows an example air conditioning and refrigeration system 100 with a handheld central or main field test and measurement instrument (hereinafter, “main unit”) 120, according to one embodiment. The main unit 120 comprises: a handheld-sized instrument with means for receiving a plurality of (ex. 1 through n) inputs 122 via physically wired connections to sensors or sensor modules, via wireless communications with sensor or sender units or sensor modules, or via a combination of the two; means for sending/transmitting a plurality of (ex. 1 through m) outputs 124 via wireless and/or wired connections with various external output devices; a display 126; and control buttons 128 and/or up, down, right, left, scroll, and select navigation controls 130.

The exemplary HVAC/R system 100, or system under test, shown in FIG. 1 may be any of a wide variety of systems, such systems being described and illustrated more thoroughly in HVAC/R systems treatises, for example the Air-Conditioning, Heating, and Refrigeration Institute's published reference text, Fundamentals of HVAC/R, by Carter Stanfield and David Skaves, copyright 2010, Prentice Hall, which is incorporated herein by reference. The system 100 shown in FIG. 1 is presented as a typical HVAC/R system under test, having a compressor 102, a condenser 106, a metering device 112, and an evaporator 114. Refrigerant (and some lubricating oil) generally flows through piping, as indicated in FIG. 1, in a clockwise direction from the compressor 102, through the condenser 106, through a metering device 112 (which may, for instance, be a capillary tube type structure or a thermal expansion valve (TEV) device), through an evaporator 114, and back to the compressor 102. Not all components are shown. For example, an oil separator may be positioned immediately after (i.e. downstream from) the compressor 102 along hot gas line 104 with an oil return line from the oil separator back to the compressor; a receiver may be positioned after the condenser 106 between the condensate line 108 and the liquid line 110 leading to (i.e. upstream from) the metering device 112; and an accumulator may be positioned along the suction (vapor) line 116 after the evaporator 114 and before the compressor 102.

Generally, the compressor 102 and metering device 112 delineate a low side (or low pressure side) 132 and a high side (or high pressure side) 134 of the HVAC/R system 100, with the compressor 102 causing refrigerant to flow from the low side 132 to the high side 134 in response to operational controls and safeties 118 associated with the compressor via electrical control lines 160. The compressor 102 delivers pressurized refrigerant to the hot gas line 104 and condenser 106. As refrigerant flows through the condenser 106, it transitions from a vapor phase 136 where only vapor is in the lines, to a liquid plus vapor phase 138 within the condenser 102, and finally to a liquid only phase 140. Outside ambient air 142 flows into the condenser coils of the condenser 106, receives heat from the high pressure refrigerant as the refrigerant condenses from a vapor to a liquid, and leaves the condenser coils as (heated) discharge air 144.

Refrigerant flows from liquid line 110 through metering device 112, through which the line pressure drops from high pressure before the metering device 112 to low pressure following the metering device 112. The low pressure refrigerant then flows in a liquid phase 140 into the evaporator 114, transitions into a vapor plus liquid phase 138 as the refrigerant absorbs heat from return air 146 flowing through the evaporator coils (thereby cooling the intake/return air 146 to provide cooled supply air 148) and finally transitions into a vapor phase 136, leaving the evaporator 114 through suction (vapor) line 116. The low pressure suction (vapor) line 116 refrigerant then flows into the compressor 102 to complete (and repeat/restart) the cycle of refrigerant flow through the HVAC/R system 100.

Low and high side test and measurement points are shown in FIG. 1. For example, the temperature of the low side or suction line near (just before) the compressor 102 may be measured at temperature measuring point 150. The temperature of the suction line (at 150) along with the pressure measurement at the suction line port 152 near (just before) the compressor 102 is typically used to check system superheat. Superheat may be defined as (suction line temperature) minus (evaporator saturation temperature). Suction line temperature is typically measured, and evaporator saturation temperature is approximated using measured suction line pressure and pressure-temperature charts (or look-up tables) for the particular type of refrigerant used in the system under test.

The temperature of the high side or condensate line leaving the condenser 102 may be measured at temperature measuring point 154. The temperature of the condensate line (at 154) along with the pressure measurement at the condensate line port 156 near (just after) the compressor 102 are typically used to check system subcool. Subcool may be defined as (condenser saturation temperature) minus (condensate line temperature). Condensate line temperature is typically measured, and condenser saturation temperature is approximated using measured condensate line pressure and pressure-temperature charts (or look-up tables) for the particular type of refrigerant used in the system under test.

Methods for charging HVAC/R systems for proper superheat and subcooling are well established but vary in application according to the particular type of system (and refrigerant) and require reference to manufacturer specifications, charts, graphs, or other data. Measuring the operating superheat of a thermal expansion valve (TEV) type metering device 112 to, for example, adjust the TEV, typically involves measuring suction (vapor) line temperature and pressure at the expansion valve bulb 158, since this is where the TEV senses the suction line temperature in its operation and function to maintain a constant system superheat. A TEV type metering device 112 typically includes a thermostatic expansion valve bulb 158 with capillary tube back to the power head of the TEV metering device 112 or a thermistor at 158 electrically connected with the TEV metering device 112 if an electronically controlled TEV metering device 112 is used. Once the TEV is adjusted for the desired superheat (for example, to maintain a superheat of 8-12 degrees F.), proper charging of the system 100 having a TEV type metering device 112 may be checked by measuring system subcool (by measuring condensate line pressure at 156 and condensate line temperature at 154) and using a subcooling charging chart (i.e. look-up table) which specifies a desired subcooling corresponding to measured outdoor ambient air temperature and measured indoor wet bulb temperature (or calculated indoor wet bulb temperature using measured relative humidity). If the measured subcooling is less than specified by the charging chart, then the system is undercharged refrigerant should be added. If the measured subcooling is greater than specified, then the system is overcharged and the excess refrigerant should be recovered.

For systems having a fixed restriction type metering device 112 (such as a capillary tube type metering device 112), proper charging of the system may be checked by measuring system superheat (by measuring suction line pressure at 152 and suction line temperature at 150) and using a superheat charging chart which specifies a desired superheat corresponding to measured outdoor ambient air temperature and measured indoor wet bulb temperature (or calculated indoor wet bulb temperature using measured return air temperature and relative humidity). If the measured superheat is more than specified by the manufacturer's charging chart, then the system is undercharged and refrigerant should be added. If the measured superheat is less than specified, then the system is overcharged and the excess refrigerant should be recovered.

Another method, sometimes referred to as the Liquid-Ambient method, for determining whether a system is over or undercharged is to measure the condensate line (or liquid line) temperature at 154 and subtract the measured outdoor ambient temperature at 142. The difference is then compared with the manufacturer's specifications. If the difference is more than specified, then the system is undercharged. If the difference is less than specified, then the system is overcharged.

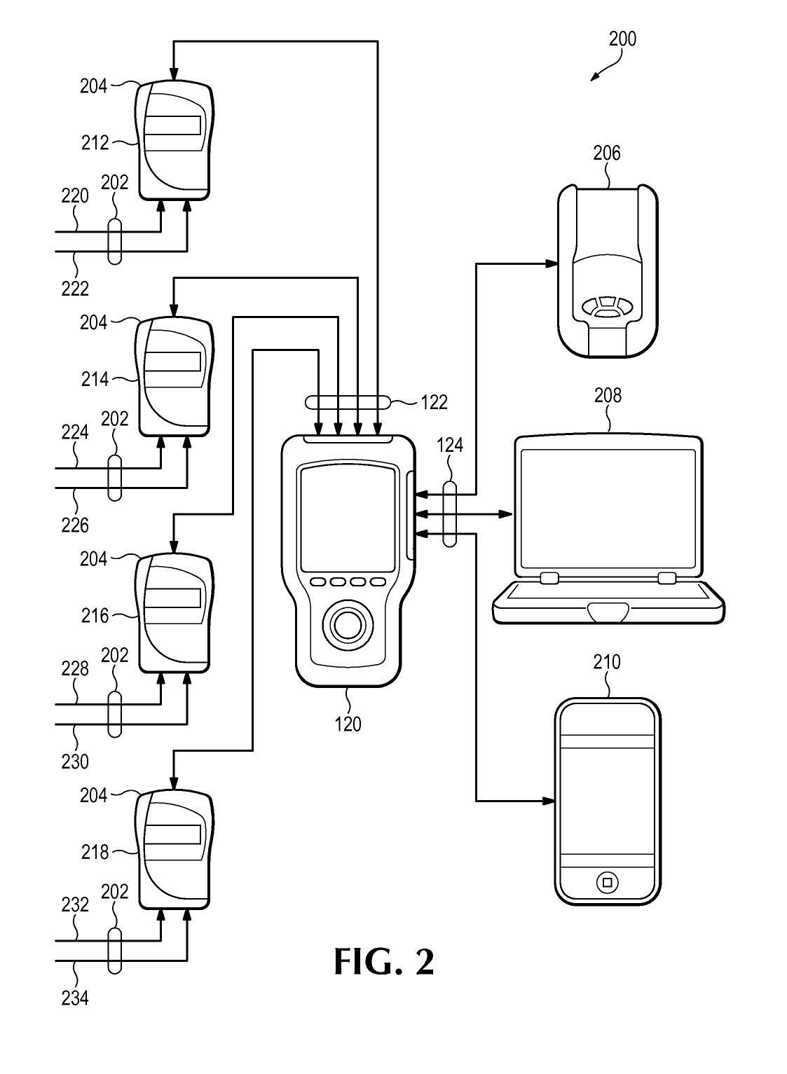

In various embodiments, the main unit 120 may be connected, as shown in FIG. 2, as a system 200 with its 1 through n inputs 122 comprising wired or wireless communication between sensor sender units (or sender modules) 204 and the main unit 120, and with its 1 through m outputs 124 comprising wired or wireless communication between the main unit 120 and various external output and peripheral devices 206, 208, 210. Exemplary external output and peripheral devices may include any of a wide variety of devices, such as IR printer or other printing devices 206, laptop or other computing device connected with the main unit 120 via IR, USB, or other means, and/or smartphone or PDA devices communicating with the main unit 120 via Bluetooth, mini USB, or other means. Each of the sender units 204, as shown, receive sensor inputs 202 from sensors suitably applied to a system under test such as the system 100 in FIG. 1, and communicate, preferably in real-time, the sensor input information to the main unit 120, which in turn preferably monitors in real-time and receives the transmitted sensor input information.

The sender units 212, 214, 216, 218 may, for example, comprise sender units with circuitry adapted for particular types or groupings of sensor inputs 202. The sender unit 212 may, for example, be adapted for location outside at the condenser 106 for measuring system subcool. For example, such a sender unit 212 may be connected to a pressure sensor via connection 220 and a temperature sensor via connection 222 for receiving, respectively, signal information representing high side pressure at condensate line pressure port 156 and signal information representing high side temperature at the condensate line temperature measuring point 154. In similar fashion, the sender unit 214 may be adapted for location outside at the compressor 102 for measuring superheat, with connections to a pressure sensor via connection 224 and a temperature sensor via connection 226 for receiving, respectively, signal information representing low side (suction line) pressure at 152 and signal information representing low side temperature at the low side temperature measuring point 150.

The sender unit 216 may be adapted for location inside at the evaporator 114 duct work for taking return air 146 temperature and relative humidity measurements, with connections to a temperature sensor via connection 228 and a humidity sensor via connection 230 for receiving, respectively, signal information representing return air 146 temperature and signal information representing return air 146 humidity.

The sender unit 218 may be adapted for location outside at the condenser 106 for taking outside ambient air 142 temperature, with connection to a temperature sensor via connection 232 for receiving signal information representing outside ambient air 142 temperature, to, for example, use the Liquid-Ambient method for checking system refrigerant charge. In such application the sender 218 may also be adapted for taking condensate line (or liquid line) temperature at 154, with connection to a temperature sensor via connection 234 for receiving signal information representing condensate (liquid) line temperature at 154. Configuring a sender with both temperature sensing inputs needed for use of the Liquid-Ambient method of charging allows for calibration within the sender or main unit 120 of the two temperature sensors to permit more accurate measurement of the temperature difference between the (higher) liquid line temperature and the (lower) outside ambient air temperature, since calibration differences between the two sensors (if two different temperature sensors are used instead of separate measurements using a single sensor) would likely adversely influence system charging.

The sender unit 218 may be adapted instead for location inside at the evaporator 114 for taking temperature and pressure measurements near the TEV bulb 158. In such an application, the sender unit 218 may have connection to a temperature sensor via connection 232 and a pressure sensor via connection 234 for receiving, respectively, signal information representing suction line temperature at 158 and signal information representing suction line pressure at 158.

Instead of configuring the sender units 212, 214, 216, 218 as above, i.e. having sensor inputs grouped according to typical application needs such as (one sender configured for) measuring high side pressure and temperature for measuring superheat, the sender units may be configured to support particular types of sensor inputs. For example, sender unit 212 may be adapted for taking refrigerant line temperatures, with connections to temperature sensors via connections 220 and 222 for receiving signal information representing refrigerant line temperatures, and sender 214 may be adapted for taking refrigerant line pressures, with connections to pressure sensors via connections 224 and 226 for receiving signal information representing refrigerant line pressures.

Preferably, each of the sender units 204 include circuitry adapted to permit wireless transmission of sensor information characterizing sensor inputs 202 for wireless reception by circuitry incorporated in the main unit 120 for wirelessly receiving the sensor information from the sender units 204. In other embodiments, the sender units 204 may include sender units with such wireless transmitting means and/or sender units requiring physically wired communication with the main unit 120.

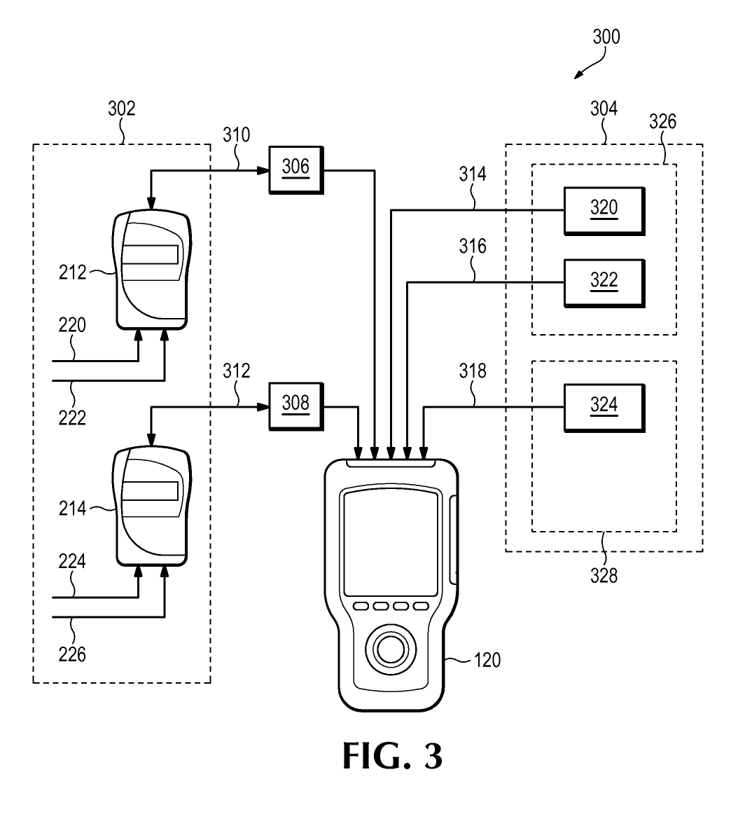

In still other embodiments, the main unit 120 may not include circuitry adapted to wirelessly receive sensor input information directly. As shown in FIG. 3, some sensors and sender units 302 may be in wireless communication with the main unit 120 via wireless transceivers 306, 308, and other sensors and sensor modules 304 may be in directly wired communication with the main unit 120. For example, sender units 212, 214 as previously described may be located outside at the compressor 102 and condenser 106 and communicate wirelessly to wireless transceivers 306, 308 via wireless channels 310, 312. The transceivers 306, 308 in turn provide the main unit 120 with sensor information via wired inputs 122. Other sensors 320, 322, 324 may be located inside at the evaporator and return air duct work and communicate directly via respective wired connections 314, 316, 318 to the inputs 122 of the main unit 120.

In one embodiment, sensor and sender units 302 comprise wireless sender units 212, 214 as previously described for providing sensor input information needed for checking superheat and subcool. The wireless transceivers 306, 308 enable the main unit 120 to receive sensor information from the sender units 212, 214 wirelessly so that the main unit 120 may be located remotely from the compressor 102 and condenser 106 of the system under test 100. Sensor and sensor modules 304 include a temperature probe or temperature probe module 320 adapted for receiving signal information representing return air 146 temperature; a humidity sensor or humidity sensing module 322 adapted for receiving signal information representing return air 146 humidity; and a temperature probe or temperature probe 324 adapted for receiving signal information representing suction line temperature at the TEV bulb 158. In one embodiment, the temperature probe modules 320 and 322 together (shown as 326 in FIG. 3) provide the functionality of sender unit 216 and the temperature/humidity probe 228/230 shown in FIG. 2. In one embodiment, the temperature probe module 324 (shown as 328 in FIG. 3) provides the functionality of sender unit 218 insofar as the temperature sensor 232 shown in FIG. 2.

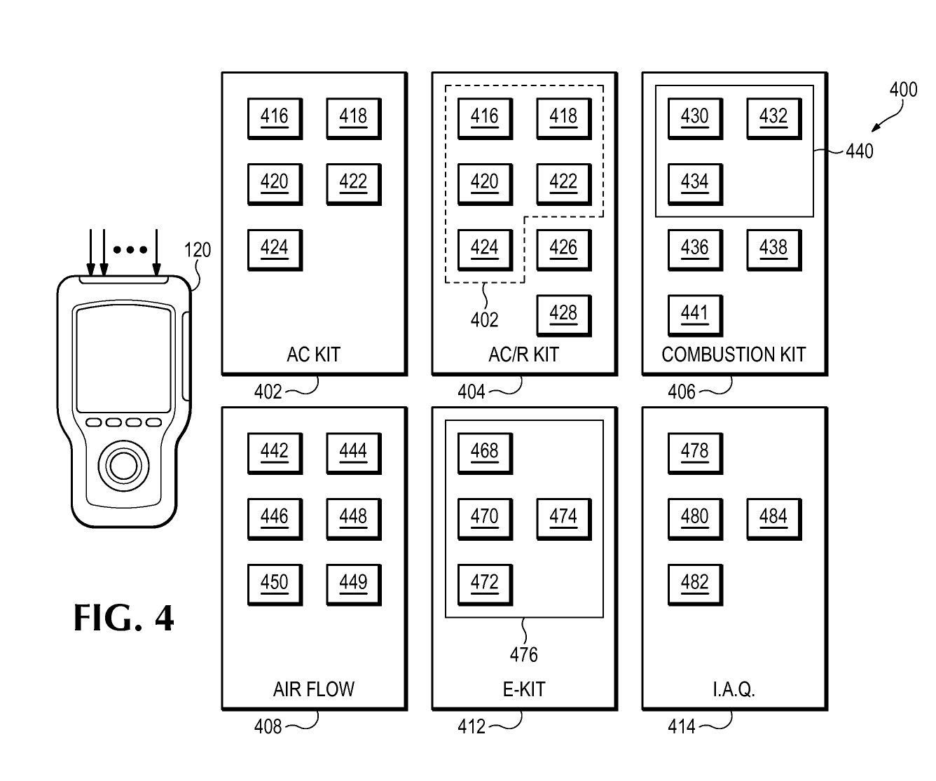

As shown in FIG. 4, the handheld HVAC/R test and measurement instrument 120 may be combined with a range of optional sensor/module kits 402, 404, 406, 408, 412, 414 as a complete HVAC/R test and measurement system 400, according to various embodiments. In one embodiment, a technician may use the central, main unit 120 with one or more of the optional sensor kits depending upon the application. Other sensor kits may be used, and the kits described are exemplary of typical HVAC/R test and measurement applications and may include different sensors, sender units, probes, or modules than those shown and described. Each kit preferably includes the appropriate probes, sensor attachments, wiring leads, cabling, sensor signal senders/transmitters, transceivers/receivers (if needed) for attachment to the main unit 120, and other equipment and circuitry for physically taking the desired system measurement (i.e. suction line pressure) and providing sensed measurement signal information (referred to as sensor inputs) receivable by the main unit 120 sensor inputs 122.

The AC kit 402 includes the sensors, sender units, probes, or modules needed to provide the main unit 120 with sensor input information for measuring outdoor ambient temperature, indoor return air temperature, indoor relative humidity, and either the low side (suction line) temperature and pressure needed for measuring superheat or the high side (discharge/condensate/liquid line) temperature and pressure needed for measuring subcool. In one embodiment, AC kit 402 includes a pressure sensor 416 and temperature sensor 418 for measuring pressure and temperature, respectively, of typical refrigerant lines in HVAC/R systems such as system 100 in FIG. 1. The pressure and temperature sensors 416, 418 are preferably equipped with Schrader or other standard refrigerant line pressure test port fittings, pipe engaging sensor clamps for quality transducer contact for measuring refrigerant (line) temperature, adequate wire/cable lengths, and other features for convenient measurement of superheat and subcool (an similar measurements for adjusting a thermal expansion valve). The pressure sensor 416 and temperature sensor 418 may be as described and shown in FIG. 2 for either of the sensor inputs 220 and 222 described for measuring subcool and 224 and 226 described for measuring superheat. AC kit 402 preferably also includes indoor temperature probe 420, humidity probe 422, and outdoor temperature sensor 424, which may be as described for indoor temperature probe, humidity sensor, and outdoor temperature sensor inputs 228, 230, and 232, respectively, described and shown in FIG. 2.

The AC/R kit 404 includes everything in the AC kit 402 plus the additional sensors, sender units, probes, or modules needed to provide the main unit 120 with the sensor input information needed for measuring both superheat and subcool. For example, AC/R kit 404 preferably includes all the sensors and probes 416, 418, 420, 422, 424 in the AC kit 402 plus an additional pressure sensor 426 (which may be substantially similar to pressure sensor 416) and an additional temperature sensor 428 (which may be substantially similar to temperature sensor 418). The AC/R kit 404 may include a combination of wired and wireless sensors, sender units, and transceivers/receivers as described and shown in FIG. 3, to provide a combination of wired and wireless remote sensor test and measurement means using a central/main unit 120.

The Combustion kit 406 includes the sensors, sender units, probes, or modules needed to provide the main unit 120 with sensor input information for measuring CO2 percentage, carbon monoxide (CO) percentage, CO ppm, inlet or ambient temperature, flue temperature, draft pressure, and gas pressure. For example, Combustion kit 406 preferably includes an oxygen (O2) sensor 430, a carbon monoxide (CO) sensor 432, a differential pressure sensor module 434 (for measuring draft and gas line pressures), a temperature probe 436 (for measuring temperature inlet combustion air entering the combustion chamber for ducted inlet combustion equipment or ambient air for ambient combustion air equipment), and a second temperature probe 438 (for measuring flue gas temperature past the heat exchanger, in the chimney of the heating system). The Combustion kit 406 preferably further includes an external unit 440 attachable to (for example, the back of) the main unit 120 and having its own power supply, the external unit 440 including, in one embodiment, the oxygen sensor 430, the carbon monoxide sensor 432, and the differential pressure sensor module 434. The Combustion kit 406 preferably includes a flue gas sample probe 441, for sampling flue gas in the chimney.

The Air Flow kit 408 includes the sensors, sender units, probes, or modules needed to provide the main unit 120 with sensor input information for measuring air flow velocity, air temperature, relative humidity, wet bulb temperature (calculated), dew point (calculated), change in dew point, and pressure differential. The Air Flow kit 408 preferably includes an air vane 442 for sensing air flow velocity, a low pressure probe 444 adapted to sense return air static pressure, another low pressure probe 446 to sense supply air static pressure (for differential pressure measurements across the blower), and indoor temperature and humidity probes 448, 450 as described for indoor temperature probe 228 and humidity sensor 230, respectively, described and shown in FIG. 2. In one embodiment, low pressure probes 444, 446 provide measurement of return air static pressure plus supply air static pressure, the combined total being comparable with equipment specifications for determining proper system functioning and system performance. The Air Flow kit 408 may include an additional temperature probe 449 for measuring the temperature rise through the furnace and using the temperature difference to estimate air flow (CFM). Temperature probe 448 may be used to measure return air temperature, temperature probe 449 may be used to measure supply air temperature, and the difference between the two is the temperature rise/difference (TD). The air flow (CFM) may then be approximated as (the furnace output in Btu/hour) divided by (TD times 1.08).

The Electrical kit (E-kit) 412 includes the sensors, sender units, probes, or modules needed to provide the main unit 120 with sensor input information for measuring voltage, current, resistance, and other common electrical measurements (i.e. capacitance, frequency, duty cycle, diode function, temperature). The E-kit 412 preferably includes a voltage probe 468, a current probe 470, a resistance probe 472, other probes such as, for example, capacitance, frequency, or temperature probes, and an external device 476 capable of converting measured parameters to a signal having sensor input information receivable by the main unit 120. The external device 476 may also include common leads and attachments (such as, for example, a common ground lead), high impedance circuitry for voltage measurements, low impedance circuitry for current measurements, and circuitry for selecting between AC and DC measurements. The E-kit 412 may substantially comprise the functionality and features of a digital multi-meter combined with circuitry adapted to provide test and measurement information to the main unit 120 via sensor inputs 122.

The Indoor Air Quality (I.A.Q.) kit 414 includes the sensors, sender units, probes, or modules needed to provide the main unit 120 with sensor input information for measuring CO2, air temperature, relative humidity, and pollutant concentration/detection. The I.A.Q. kit 414 may include an oxygen (O2) sensor 478 for measuring carbon dioxide percentage, a temperature probe 480, a humidity probe 482, and one or more pollutant sensors 484.

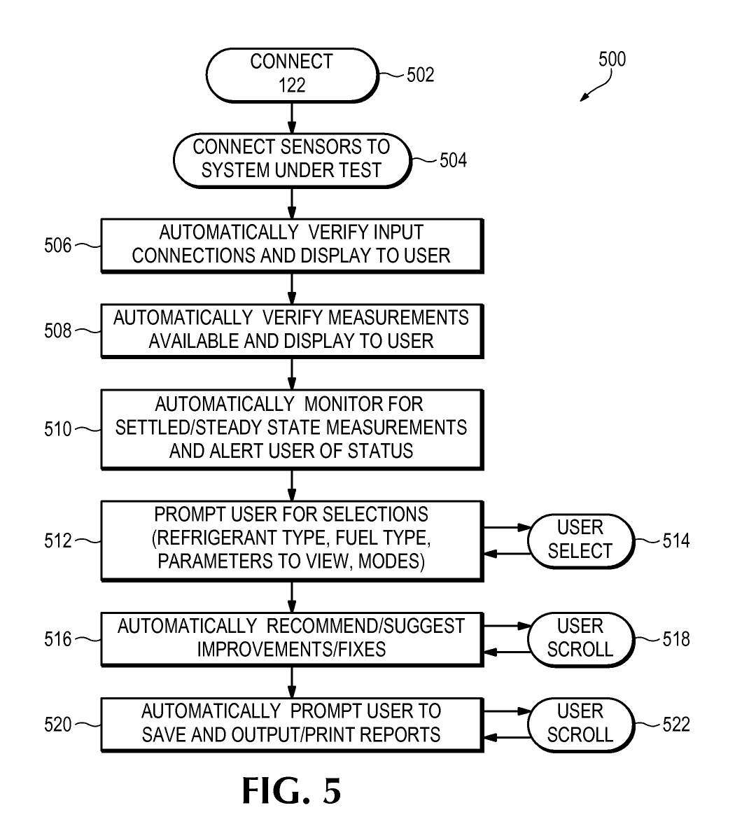

A partial, generalized operational flow chart of a handheld HVAC/R test and measurement instrument 120 with kits 400, according to various embodiments, is shown in FIG. 5. Other steps may be added, and steps may be omitted. However, operation of the main unit 120 preferably includes the following general steps, functionality, and features. Generally, sensor inputs 122 from a chosen kit of sensors (from a range of optional kits 400) are connected (step 502) with the main unit 120, and the sensors (probes, sender units, etc.) associated with the chosen kit are connected to the system under test (step 504). Upon power up of the main unit 120 and any components of the chosen kit requiring power, and once the sensors are connected to the system under test and sensor inputs 122 connected with the main unit 120, the main unit 120 automatically detects and verifies what is connected to it and (step 508) the tests, measurements, and analysis functions that may be performed using the sensor information available. That is, preferably, the main unit 120 automatically verifies the sensor inputs 122 (in terms of what type of sensor are connected and, also preferably, whether such sensors are working properly). The sensor input 122 information (i.e. sensor connections, sensor functioning status, sensor information being transmitted/received in real-time) is then provided to the main unit 120 for display to the technician/user. The main unit 120 preferably automatically monitors (step 510) the sensor inputs 122 for settled/steady state sensor measurement information and alerts the technician (visually, audibly, and/or tactilely) of the status of the connected sensors, status of the system 100 (for example, the settling of subcool or superheat measurements following a change in refrigerant charge, the presence of hazardous gas concentrations near the furnace warranting improved ventilation, whether the sensed measurement information is within typical/expected operating ranges), and the status of analysis or tests in-process or to be performed (for example, the status of data-logging). In one embodiment, the main unit 120 automatically monitors sensor inputs 122 and provides the technician with alerts and indications regarding safety conditions of workspaces, for example, alerting the technician if refrigerant is detected or if oxygen levels are becoming too low (or trending downward) so as to present workspace safety concerns.

The main unit 120 preferably provides the user/technician with real-time display of the sensor inputs 122 so the technician can watch the measurements/sensor inputs change in real-time. In preferred embodiments, the main unit 120 also provides the user/technician with real-time display of the (computed/calculated/estimated) output values (such as, for example, superheat, subcool, combustion efficiency, etc.) as those output values change in response to dynamically changing sensor input values. That is, the main unit 120 allows a technician to not only view all sensor inputs simultaneously, but also to view outputs/results/computations in real-time. In one embodiment, the main unit 120 allows the technician/user to enter “what if” input values or other parameters (such as, for example, a temperature value, refrigerant type, manufacturer model number, or other measured or referenced value that may influence calculated or estimated measurements such as superheat) to determine what impact, if any, such hypothetical input or reference value or parameters, if different, would have on the real-time displayed output values and results.

In most superheat or subcool measurements, it is recommended to start the HVAC/R system and let it run for 10-30 minutes to allow the temperatures and pressures to stabilize before taking measurement values. In preferred embodiments, as described previously, the main unit 120 includes programming instructions and circuitry adapted to monitor sensor inputs 122 in real-time and detect when system 100 temperatures and pressures have settled/stabilized (step 510). In one embodiment, the main unit 120 also provides the technician with an indication of the expected time that will be needed to reach such settled/stabilized system temperatures and pressures, enabling the technician to multi-task or focus on another activity during waiting periods. In one embodiment, the main unit 120 alerts the technician of settled sensor inputs (step 510). In preferred embodiments, the main unit 120 provides alerts to the technician when predetermined target values are reached. For example, the main unit 120 preferably provides the technician with step-by-step guidance for tests such as target evaporator exit temperature in addition to common testing for superheat, subcooling, and combustion. Once the target evaporator exit temperature (i.e. once supply air 148 exiting evaporator 114 in system 100 reaches a target value) the main unit 120 provides an alert to the technician.

The main unit 120 preferably automatically prompts the technician/user for user-input selections 514 such as refrigerant type, fuel type, parameters to view/display, or modes of operation of the main unit 120 depending upon the automatically detected sensor inputs 122 and automatically determined available measurements and analysis available to the user. The main unit 120 preferably (step 516) includes sufficient programming instructions to provide recommendations, suggestions for system performance improvement, troubleshooting guidance, and so forth, based upon the real-time monitoring of the sensor inputs 122. Preferably, the user is able to scroll 518 through such automatically provided troubleshooting and analysis guidance information to select and drill down through menu information to access additional information and suggestions and to perform the desired system analysis.

In one embodiment, the main unit 120 provides the user access to not only suggested testing and measurement procedures and troubleshooting assistance, but also access to reference information and underlying practical application principles and best practices so as to present the user with the depth of vocational training and information available from technical handbooks commonly carried by field technicians, or, preferably, the in-depth reference information available from treatises such as the aforementioned Air-Conditioning, Heating, and Refrigeration Institute's published reference text. Such technical reference and training information may be stored on-board the main unit 120 or accessed by the main unit 120 via wi-fi, Ethernet, cell, or other network connection. For example, technical reference information may be accessed through a smartphone application designed for retrieval and mobile presentation to a field technician. Preferably, main unit 120 provides the user/technician access and prompts to relevant technical reference information that is in response to the main unit's determination of the kit of sensors 400 being used, the automatically detected and verified sensor input information being received, monitored, and presented for display to the user in real-time, and the automatically determined recommendation/troubleshooting/system analysis information. In preferred embodiments, main unit 120 provides the user with technical database information with possible causes for erroneous readings/measurements.

In one embodiment, the main unit 120 automatically saves into memory test and measurement information useful for typical system testing and analysis, and that is most commonly used when reporting system performance. The main unit 120 then alerts the user of the automatically saved data, providing the user options whether continue retaining the data in memory or allow the automatically saved data to be overwritten as additional memory is needed. The main unit 120 preferably (step 520) automatically prompts the user to save pertinent test and measurement results (in memory on-board the main unit 120 or storage accessible to the main unit 120) and provides the user with output options such as printing on a networked or connected printer, export data to a laptop or other device, or send data via email or to a smartphone, PDA, or other external device. The main unit 120 preferably prompts the user to save pertinent data and output typically used service and system performance reports, allowing the user to scroll (step 522) through such saving and reporting/output options.

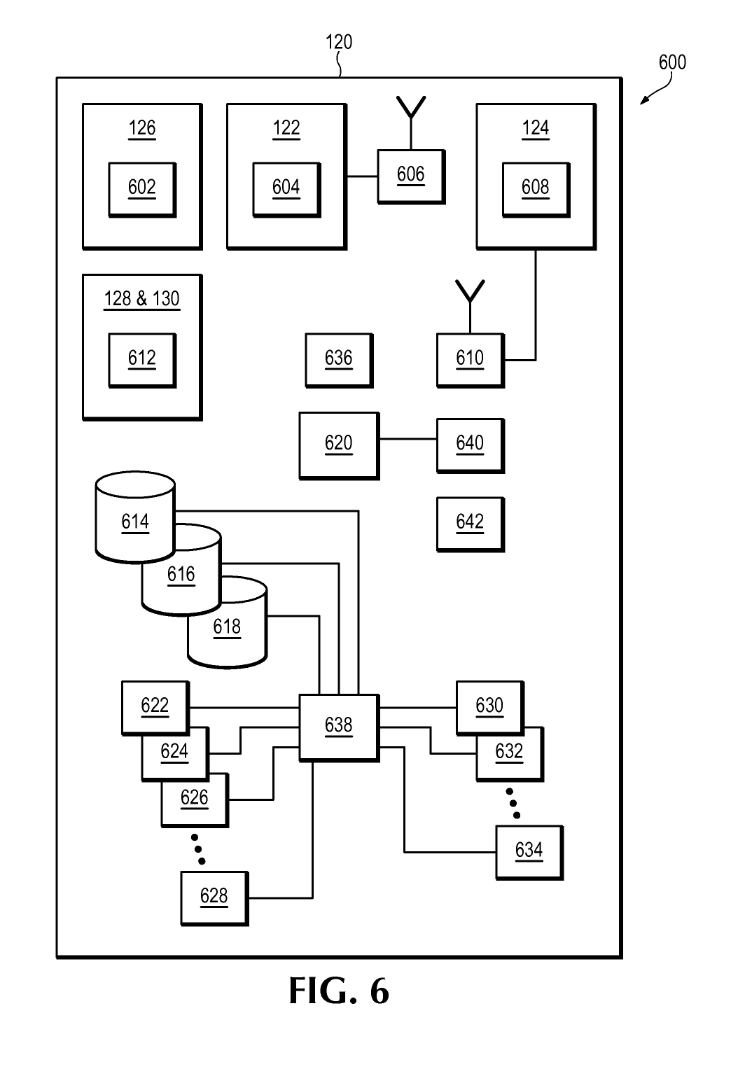

Although different circuitry, hardware, and software arrangements/architectures may be used, an exemplary functional block diagram 600 of a handheld HVAC/R instrument (or main unit) 120 is illustrated in FIG. 6, in accordance with various embodiments. The main unit 120 preferably includes drivers and circuitry 602 for the display 126 and drivers and circuitry 612 for the key pad 130 and function/selection buttons 128. Drivers and circuitry 604 and 608 are provided for the physical inputs 122 and physical outputs 124, respectively. Physical inputs 122 may be any of a wide variety of configurations—USB, mini-USB, DIN, or other wired signal transmitting/receiving means. The main unit 120 is preferably equipped with drivers and circuitry 606 and 610 for wirelessly transmitting/receiving, respectively, sensor inputs 122 and main unit outputs 124. The main unit 120 also includes an internal power supply 636 and audio drivers and circuitry 642.

Databases 614, 616, 618 are preferably included in main unit 120 for providing troubleshooting, system analysis, improvements, possible causes of erroneous readings, user guidance steps/functions, and other technical reference information. Memory 622, 624, 626, 628 is preferably included for look-up tables (LUTs) and calculation algorithms needed to support the sensor kits 400. On-board memory 630, 632, 634 that is writable by external devices such as, for example, laptop 208 or smartphone 210, and via SD card, flash drive devices, etc. may be included in main unit 120 for loading additional or updated LUTs, software, customer ID information, and other data. Memory, LUT, and database management circuitry 638 is preferably included for handling software changes, updates, and operation of the main unit 120.

Microprocessor 620 and supporting circuitry preferably provides the main unit 120 with processing means for executing stored programming instructions, access to on-board and accessible databases and memory, calculations, execution of algorithms, and other computing needs. Additional processing capacity 640 is preferably included for real-time monitoring and display of input data, preferably real-time monitoring of all inputs simultaneously or substantially simultaneously.

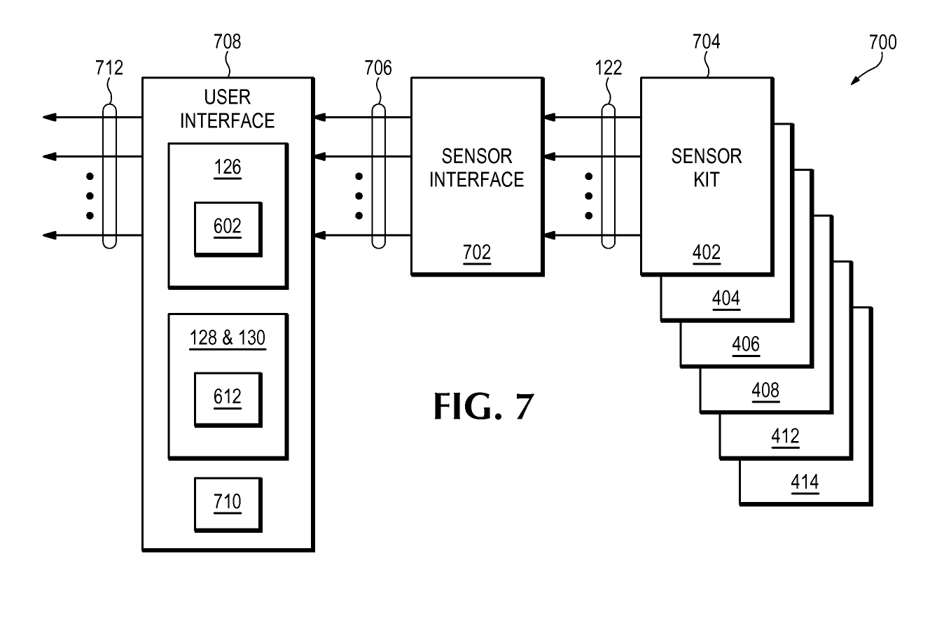

Instead of the main unit 120 receiving sensor inputs 122 and directly providing outputs 124, in other embodiments of the present invention the function and capabilities of the central/main unit 120 may be divided, as shown (as system 700) in FIG. 7, into a handheld sized test and measurement data interface unit 702 for receiving sensor inputs 122 from sensor kits 704 and providing received sensor input information 706 to a handheld sized user interface 708, which in turn provides outputs 712 in the same way as described herein for the outputs 124 from main unit 120. The sensor kits 704 are as in FIG. 4, including kits 400, as shown as kits 402, 404, 406, 408, 412, 414. The interface unit 702, in one embodiment, provides all functionality of the main unit 120 (for receiving sensor inputs from sensor kits 704) except for display 126, key pad 130 and buttons 128 (i.e. most user interface functions) which are provided by the user interface 708. The user interface 708 may also include databases 614, 616, 618 for providing troubleshooting, system analysis, improvements, possible causes of erroneous readings, user guidance steps/functions, and other technical reference information. In some embodiments the user interface 708 includes displays, key pad or user input features, and data processing capabilities. Functional components 710 in the user interface 708 may include a power supply (such as 636), memory/memory management circuitry (such as 638), databases 614, 616, 618, and wired/wireless transmission/reception circuitry (such as 604, 606, 608, 610).

In one embodiment, the sensor interface 702 provides means for receiving sensor inputs 122 (from sensor kits 704) and transmitting sensor information 706 configured and arranged for reception by a user interface 708 such as a field portable tablet computing device, netbook, or smartphone device which can receive the transmitted sensor information and perform the data processing and user interface and feedback capabilities described herein provided by the main unit 120. In another embodiment, the sensor interface 702 comprises all functionality and capabilities (and databases, data processing means, etc.) as main unit 120, with the display 126 and user input features such as control buttons 128 and/or up, down, right, left, scroll, and select navigation controls 130 may be omitted in lieu of those user interface capabilities provided by an external device such as smartphone 210. In such fashion the housing and components required for such a sensor interface 702 may be reduced in cost, size, and complexity, and a greater variety of devices may be used to provide the physical user interface for the technician. For example, the technician may choose to use a particular tablet computing device as a preferred user interface in combination with sensor interface 702 and sensor kits 704. In such an embodiment, sensor interface 702 and sensor kits 704 provide all the functionality and capabilities described for main unit 120 herein, with the technician's choice of user interface device either substituting for display and physical user interface features not included with sensor interface 702 or complementing the display and physical user interface features and capabilities of sensor interface 702.

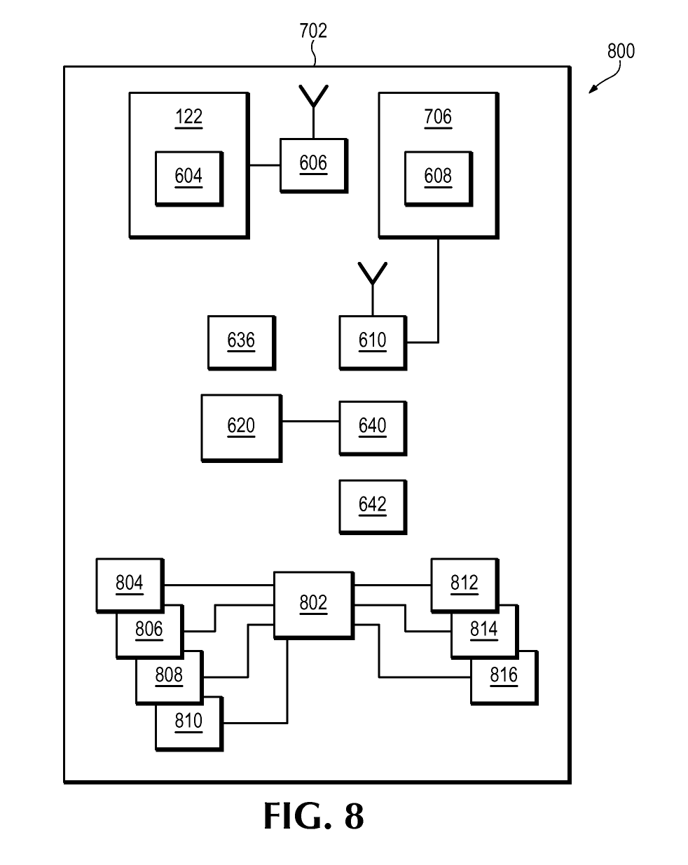

FIG. 8 shows an exemplary functional block diagram 800 of a handheld sized data interface unit 702 as in FIG. 7, according to various embodiments. Preferably, functionally and physically, the combination of sensor interface 702 and the user interface 708 include all features and capabilities of the main unit 120 described previously. That is, in preferred embodiments, the sensor inputs 122 shown in FIG. 7 and in FIGS. 1-3 (and in all figures described herein) work in basically the same way, and, likewise, the user interface outputs 712 shown in FIG. 7 work in basically the same way as main unit 120 outputs 124 in FIGS. 1-3 (and all figures described herein). Drivers and circuitry 604 and 608 are provided for the physical inputs 122 and physical outputs 706, respectively. Physical inputs 122 may be any of a wide variety of configurations—USB, mini-USB, DIN, or other wired signal transmitting/receiving means. The interface unit 702 is preferably equipped with drivers and circuitry 606 and 610 for wireles sly transmitting/receiving, respectively, sensor inputs 122 and outputs 706. The interface unit 702 also includes an internal power supply 636 and audio drivers and circuitry 642.

Memory 804, 806, 808, 810 is preferably included for data pertaining to function/operation of the sensor kits 400. On-board memory 812, 814, 816 that is writable by external devices such as, for example, user interface 708, and via SD card, flash drive devices, etc. may be included in interface unit 702 for loading additional or updated software and other data. Memory management circuitry 802 is preferably included for handling software changes, updates, and operation of the interface unit 702.

Microprocessor 620 and supporting circuitry preferably provides the interface unit 702 with processing means for executing stored programming instructions, access to on-board and accessible memory, and other computing needs. Additional processing capacity 640 is preferably included for real-time monitoring and transmission of input data, preferably real-time monitoring of all inputs simultaneously or substantially simultaneously.

The terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

What is claimed is:

1. A handheld sized test and measurement data interface unit having a microprocessor, memory, and circuitry adapted to receive inputs from a plurality of sensors communicably coupled with a system under test and said interface unit, and to automatically determine a sensor type for each one of said plurality of sensors.

2. The unit of claim 1 further comprising circuitry adapted to provide information corresponding to said inputs and determined sensor types to an external data unit, said information configured so as to permit processing by said external data unit, and said external data unit sized for portable field use by a user.

3. The unit of claim 1 further comprising programming instructions operable to determine whether each one of said plurality of sensors is functioning within predetermined performance criteria corresponding to its determined sensor type.

4. The unit of claim 1 further comprising circuitry adapted to simultaneously monitor all of said inputs in real-time.

5. The unit of claim 1 further comprising an internal power supply.

6. The unit of claim 1 further comprising circuitry adapted to permit wireles sly receiving said inputs from said plurality of sensors.

7. The unit of claim 2 wherein said external data unit is adapted to receive data from said interface unit and comprises a display and a keypad.

8. The unit of claim 7 wherein said external data unit further comprises circuitry adapted to permit wirelessly receiving said data from said interface unit.

9. The unit of claim 7 wherein said external data unit further comprises output means.

10. The unit of claim 7 wherein said external data unit communicatively coupled with said interface unit further comprises application programming instructions operable to analyze said received data from said interface unit, provide said user with prompts to select from a predetermined range of further analysis and troubleshooting options based on said received data and said determined sensor types, and provide said user output options for reporting performance information of said system under test.

11. The instrument of claim 1 wherein said plurality of sensors comprise a kit of sensors preselected to provide inputs needed for a predetermined group of tests and measurements of an HVAC/R system.

12. The instrument of claim 11 wherein said kit comprises: a pressure sensor and a temperature sensor, each adapted to sense pressure and temperature, respectively, of a high side/discharge line or a low side/suction line of an HVAC/R system; a temperature probe and a humidity probe, each adapted to sense temperature and humidity, respectively, in ductwork where wet bulb temperature is measured in said HVAC/R system; and an outside temperature sensor adapted to sense outside ambient temperature of said HVAC/R system.

13. The instrument of claim 11 wherein said kit comprises: a pressure sensor and a temperature sensor, each adapted to sense pressure and temperature, respectively, of a high side/discharge line of an HVAC/R system; a second pressure sensor and a second temperature sensor, each adapted to sense pressure and temperature, respectively, of a low side/suction line of said HVAC/R system; a temperature probe and a humidity probe, each adapted to sense temperature and humidity, respectively, in ductwork where wet bulb temperature is measured in said HVAC/R system; and an outside temperature sensor adapted to sense outside ambient temperature of said HVAC/R system

14. The instrument of claim 11 wherein said kit comprises: an external unit physically attachable to said instrument, said external unit having its own power supply; an oxygen sensor for measuring CO2 percentage; a carbon monoxide sensor for measuring CO ppm; a differential pressure sensor module for sensing draft and gas line pressures; a temperature probe adapted to sense temperature of inlet combustion air for ducted inlet combustion equipment or ambient air for ambient combustion air equipment; a second temperature probe adapted to sense flue gas temperature in a chimney of said HVAC/R system; and a flue gas sampling probe for sampling gas in said chimney.

15. The instrument of claim 11 wherein said kit comprises: an air vane for sensing air flow velocity; a low pressure sensor adapted to sense return air static pressure; a second low pressure sensor adapted to sense supply air static pressure; and a temperature probe and a humidity probe, each adapted to sense temperature and humidity, respectively, in ductwork where wet bulb temperature is measured in said HVAC/R system.

16. The instrument of claim 11 wherein said kit comprises: a voltage probe module for measuring a potential difference; a current probe module for measuring a electric current; a resistance probe for measuring resistance; and an external unit having circuitry adapted to convert measured parameters from said voltage, current, and resistance probes to signals receivable as said inputs to said instrument.

17. The instrument of claim 11 wherein said kit comprises: an oxygen sensor for measuring CO2 percentage; a carbon monoxide sensor for measuring CO ppm; a temperature probe and a humidity probe, each adapted to sense temperature and humidity, respectively; and one or more pollutant sensor.

18. A handheld HVAC/R test and measurement instrument having a display, a keypad, a microprocessor, memory, and circuitry adapted to receive inputs from a plurality of sensors and to automatically determine a sensor type for each of said plurality of sensors and automatically determine and display on said display HVAC/R tests and measurements available to be performed using only said plurality of sensors.

19. The instrument of claim 18 wherein said plurality of sensors comprise a kit of sensors preselected to provide inputs needed for a predetermined group of tests and measurements of an HVAC/R system.

20. The instrument of claim 19 wherein said kit comprises: a pressure sensor and a temperature sensor, each adapted to sense pressure and temperature, respectively, of a high side/discharge line or a low side/suction line of an HVAC/R system; a temperature probe and a humidity probe, each adapted to sense temperature and humidity, respectively, in ductwork where wet bulb temperature is measured in said HVAC/R system; and an outside temperature sensor adapted to sense outside ambient temperature of said HVAC/R system.

21. The instrument of claim 19 wherein said kit comprises: a pressure sensor and a temperature sensor, each adapted to sense pressure and temperature, respectively, of a high side/discharge line of an HVAC/R system; a second pressure sensor and a second temperature sensor, each adapted to sense pressure and temperature, respectively, of a low side/suction line of said HVAC/R system; a temperature probe and a humidity probe, each adapted to sense temperature and humidity, respectively, in ductwork where wet bulb temperature is measured in said HVAC/R system; and an outside temperature sensor adapted to sense outside ambient temperature of said HVAC/R system

22. The instrument of claim 19 wherein said kit comprises: an external unit physically attachable to said instrument, said external unit having its own power supply; an oxygen sensor for measuring CO2 percentage; a carbon monoxide sensor for measuring CO ppm; a differential pressure sensor module for sensing draft and gas line pressures; a temperature probe adapted to sense temperature of inlet combustion air for ducted inlet combustion equipment or ambient air for ambient combustion air equipment; a second temperature probe adapted to sense flue gas temperature in a chimney of said HVAC/R system; and a flue gas sampling probe for sampling gas in said chimney.

23. The instrument of claim 19 wherein said kit comprises: an air vane for sensing air flow velocity; a low pressure sensor adapted to sense return air static pressure; a second low pressure sensor adapted to sense supply air static pressure; and a temperature probe and a humidity probe, each adapted to sense temperature and humidity, respectively, in ductwork where wet bulb temperature is measured in said HVAC/R system.

24. The instrument of claim 19 wherein said kit comprises: a voltage probe module for measuring a potential difference; a current probe module for measuring a electric current; a resistance probe for measuring resistance; and an external unit having circuitry adapted to convert measured parameters from said voltage, current, and resistance probes to signals receivable as said inputs to said instrument.

25. The instrument of claim 19 wherein said kit comprises: an oxygen sensor for measuring CO2 percentage; a carbon monoxide sensor for measuring CO ppm; a temperature probe and a humidity probe, each adapted to sense temperature and humidity, respectively; and one or more pollutant sensor.

26. The instrument of claim 18 wherein said memory comprises reference information and algorithms usable for calculations of superheat, subcool, and wet bulb temperature.

27. The instrument of claim 18 further comprising circuitry adapted to simultaneously monitor all inputs in real-time.

28. The instrument of claim 18 wherein said memory comprises technical information, troubleshooting steps, and testing and measuring steps, and said keypad comprises up, down, right, left, and select controls for navigating help and guide information stored in said memory and displayed on said display of said instrument.

29. The instrument of claim 18 further comprising circuitry adapted to permit wirelessly receiving said inputs from one or more of said plurality of sensors.

30. The instrument of claim 18 further comprising circuitry adapted to permit transmitting information to external devices and receiving information from one or more external device.

31. The instrument of claim 30 further comprising circuitry adapted to permit wirelessly transmitting information to and wirelessly receiving information from said one or more external device.

32. The instrument of claim 18 further comprising circuitry adapted to monitor said inputs in real-time and automatically identify inputs providing sensor information that has settled to reach steady state.

33. The instrument of claim 32 further comprising circuitry adapted to selectably provide an audible or visual alert when steady state input information has been identified.

34. The instrument of claim 32 further comprising circuitry adapted to automatically store input information.
